(19) United States
(12) Patent Application Publication
(10) Pub. No.: US 2006/0237315 A1
(43) Pub. Date: Oct. 26, 2006

(54) Gas sensor

(75) Inventors: Kouji Matsuo, Aichi (JP); Keiichi Noda, Aichi (JP); Yuichi Yamada, Aichi (JP)

Correspondence Address: SUGHRUE MION, PLLC, 2100 PENNSYLVANIA AVENUE, N.W., SUITE 800, WASHINGTON, DC, 20037, US

(73) Assignee: NGK SPARK PLUG CO., LTD.

(21) Appl. No.: 11/410,936

(22) Filed: Apr. 26, 2006

(30) Foreign Application Priority Data
Apr. 26, 2005 (JP) 2005-128374

(51) Int. Cl. G01N 27/26

(52) U.S. Cl. 204/424

(57) ABSTRACT

A gas sensor 100 includes: a cylindrical metal shell 110; a gas detection element 120; a cylindrical sleeve 170 at least partially located inside the metal shell 110, and an axial hole 170c penetrating through the sleeve and accommodating the gas detection element 120 therein; and a connector 180 joined to a rear end portion of the gas detection element 120 and spaced apart from the sleeve 170, the connector 180 including a plurality of connector terminal portions 182 to 186 electrically connected to corresponding electrode terminal portions 125 to 129.

### BACKGROUND OF THE INVENTION

1. Field of the Invention

The present invention relates to a gas sensor capable of measuring the concentration of a gas component, such as a component of an exhaust gas produced by an internal combustion engine, and more particularly to a gas sensor having a cylindrical sleeve and an axial hole formed therein for housing a gas detection element extending along an axial direction thereof.

2. Description of the Related Art

Conventionally, many gas sensors for measuring the concentration of a gas component, such as a component of an exhaust gas produced by an internal combustion engine, have been known. Such gas sensors comprise: a cylindrical metal shell; a gas detection element located inside the metal shell and extending in a rod-like manner; a cylindrical sleeve holding and accommodating the gas detection element therein; and a connector attached at a rear end side of the gas detection element and electrically connected to an electrode terminal portion of the gas detection element. An example of this type of gas sensor is disclosed in Patent Document 1. A sectional view of a conventional gas sensor 900 is shown in FIG. 6.

This gas sensor 900 includes: a cylindrical metal shell 910; a gas detection element 920 located inside the metal shell 910 and extending in a rod-like manner; a cylindrical sleeve 930 holding and accommodating the gas detection element 920 therein; and a connector 940 attached at a rear end side of the gas detection element 920. Moreover, a protector 960 is fixed at a front end side of the metal shell 910. On the other hand, a first sleeve 970 surrounding the connector 940, etc., is fixed at the rear end side of the metal shell 910, and a second sleeve 975 is additionally fixed at the rear end side of the first sleeve 970.

The gas detection element 920 projects from the metal shell 910 towards the front end side (lower part in the figure) and has a gas detection portion 921, which can detect a gas concentration, in a front end portion 920s thereof located inside the protector 960. Moreover, the gas detection element 920 has four electrode terminal portions 923 in total, which are electrically connected to the gas detection portion 921, etc., on an outer circumference face of a rear end portion 920k projecting from the metal shell 910 towards the rear end side (upper part in the figure).

The sleeve 930 assumes a cylindrical form having an axial hole 931, and most of the sleeve is located inside the metal shell 910. The axial hole 931 accommodates and holds the gas detection element 920 therein. Furthermore, a space between the gas detection element 920 and the sleeve 930 is filled with a glass sealing material 933.

The connector 940 is largely opened toward the front end side and includes an indented portion 941 for accommodating a rear end portion 920k of the gas detection element 920. Four connector terminal members 943 are provided, in resilient contact with and electrically connected to each electrode terminal portion 923 of the gas detection element 920 in a predetermined position of the indented portion 941. These connector terminal members 943 are electrically connected to leads 953 extending outside the gas sensor through the metal members 951 at the rear end side, respectively.

[Patent Document 1] Japanese Patent Application Laid-open (kokai) No. 2001-188060

3. Problems to be Solved by the Invention

However, in gas sensor 900, since sleeve 930 is in contact with a connector 940, the heat from the sleeve 930 is directly conducted to the connector 940 when in use, thereby causing a temperature rise in the connector 940. Thus, a rear end portion 920k of the gas detection element 920 connected to the connector 940 also rises to a high temperature. As a result, if the gas detection element 920 has a solid electrolyte layer in which two or more via conductors electrically connected to electrode terminal portions 923 penetrate therethrough in the rear end portion 920k, insulation performance of the solid electrolyte layer contained in the rear end portion 920k will fail, resulting in a tendency to cause a leak between the via conductors. Consequently, gas concentration may not be accurately detected.

### SUMMARY OF THE INVENTION

The present invention has been accomplished so as to solve the above problem, and an object of the invention is to provide a gas sensor capable of preventing leakage between via conductors that are provided in a rear end portion of the gas detection element.

The above object has been achieved in a first aspect (1) of the invention by providing a gas sensor comprising: a cylindrical metal shell; a gas detection element including a solid electrolyte layer, a front end portion of the gas detection element projecting from a front end portion of the metal shell and including a gas detection portion, an intermediate portion located inside the metal shell, and a rear end portion projecting from a rear end portion of the metal shell and including a plurality of electrode terminal portions and a plurality of via conductors electrically connected to corresponding electrode terminal portions; a cylindrical sleeve at least partially located inside the metal shell, and an axial hole penetrating through the sleeve and accommodating the gas detection element therein; a connector joined to the rear end portion of the gas detection element and spaced apart from the sleeve, the connector including a plurality of connector terminal portions electrically connected to corresponding electrode terminal portions.

In the invention, the rear end portion of the gas detection element includes a plurality of via conductors electrically connected to the electrode terminal portion, however, the sleeve is isolated from the connector. Thus, the heat from the sleeve is hardly conducted to the connector, thereby preventing a rise in temperature of the connector when in use. Consequently, leakage between via conductors due to high temperature is unlikely to occur, such that gas concentration may be more accurately detected than by a conventional gas sensor.

In addition, the gas sensor is not limited to any certain type of gas sensor, providing that the gas sensor satisfies the above-mentioned requirements. For example, the invention can be applied to a gas sensor, such as an oxygen sensor, an all range air-fuel ratio sensor and a NOx sensor.

Moreover, in the present invention, the form of the gas detection element is not limited, providing that the above-mentioned requirements are satisfied. For example, the gas detection element can assume the form of a hollow-tube with a closed tip end or a plate-like shape or the like.

Moreover, the via conductor is preferably formed so as to penetrate the solid electrolyte layer in the rear end portion and is not limited to any specific form. For example, the via conductor can assume a cylindrical form in which a through-hole penetrates therethrough or a pillar-shape in which a conductor is filled therein.

Notably, if the sleeve which is entirely located in the metal shell is spaced away from the connector, stress is likely to concentrate on the rear end of the axial hole of the sleeve, which may cause cracks in the sleeve.

In view of the above problem, in a second aspect (2), the invention provides a sensor according to (1) above, wherein the sleeve of the gas sensor further includes a projecting portion projecting from the rear end portion of the metal shell and supporting said gas sensor element.

Owing to such a projecting portion supporting the gas sensor element at the outside of the metal shell, the stress is dispersed so as not to concentrate on the rear end of the axial hole of the sleeve. As the result, cracks in the sleeve can be effectively prevented.

In order to efficiently support the gas sensor element, an inner circumference face of the axial hole of the projection portion and an outer circumference face of the gas detection element may be in contact with each other or a small space may be left therebetween.

Furthermore, in a third aspect (3), the invention provides a gas sensor according to (1) or (2) above, wherein the sleeve further includes: a large diameter portion having a larger diameter than that of the protruding portion and being located inside the metal shell, and a shoulder portion facing the rear side in the axial direction, and wherein the rear end portion of the metal shell is bent inwardly so as to crimp the shoulder portion.

In a gas sensor having a form such that the rear end portion of the metal shell is bent toward the radially inward direction so that the sleeve is crimped and fixed, and where the entire sleeve is located inside the metal shell and has no protruding portion at the rear end side, a large force will be imposed on the rear end side open end portion of the axial hole of the sleeve. As a result, a crack initiating from the open end portion of the axial hole of the sleeve tends to occur.

On the other hand, in the gas sensor of the present invention, since the sleeve has a protruding portion at the rear end side projecting to the rear end side, the rear end side open end portion of the axial hole, which tends to serve as the initiating point of a crack, is isolated from the rear end portion (crimped portion) of the metal shell towards the rear end side. Therefore, when the rear end portion of the metal shell is bent and crimped, a large stress will not be imposed on the rear end side open end portion of the axial hole of the sleeve. Thus, the occurrence of a crack in the sleeve will be prevented.

Furthermore, in the gas sensor described-above, the gas detection element preferably assumes the form of a plate, and the opening of the axial hole of the sleeve preferably assumes a rectangular form.

If the sleeve has a rectangular-shaped opening with no protruding portion at the rear end side, a large tensile stress will be imposed on the corner of the opening. Consequently, a crack is likely to occur in the sleeve when the rear end portion of the metal shell is crimped. However, in the present invention, since the sleeve has a protruding portion at the rear end side, the rear end side open end portion of the axial hole where a crack tends to initiate is isolated from the rear end portion (crimped portion) of the metal shell to the rear side. Therefore, the occurrence of a crack in the sleeve will be prevented, because a large force will not be imposed on the rear end side open end portion of the axial hole 170c when the rear end portion of the metal shell is crimped.

### BRIEF DESCRIPTION OF THE DRAWINGS

FIG. 1 is an external view showing a gas sensor according to a embodiment of the invention.

FIG. 2 is a sectional view showing a gas sensor according to the embodiment.

FIG. 3 is an exploded perspective view showing an insulating sleeve according to a gas sensor of the embodiment.

FIG. 4 is a decomposed perspective view showing a sensor element according to a gas sensor of the embodiment.

FIG. 5 is a perspective view showing an insulating sleeve according to comparative embodiment.

FIG. 6 is a sectional view showing a gas sensor according to the conventional art.

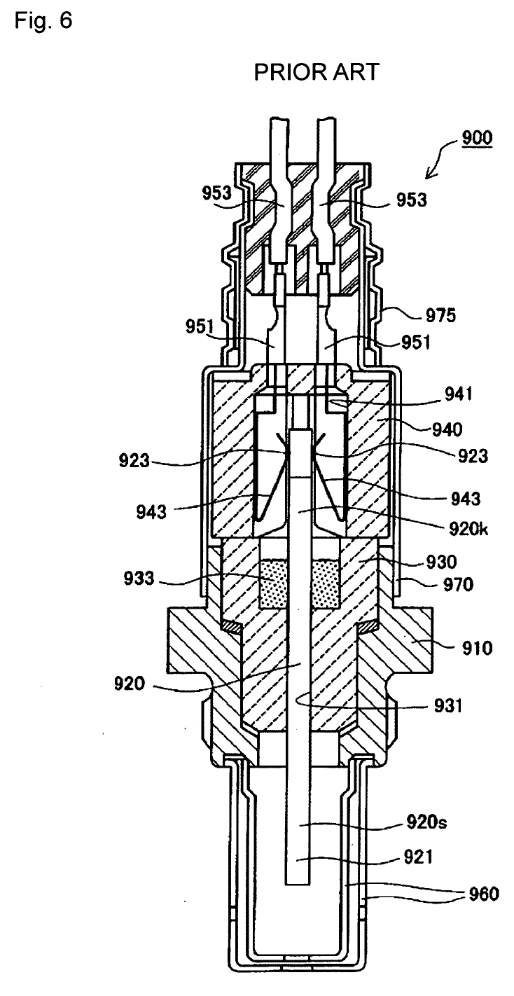

### DESCRIPTION OF REFERENCE NUMERALS

Reference numerals used to identify various structural features in the drawings including the following.
100 gas sensor
103 metal tube
110 metal shell
110k rear end portion
120 gas detection element
120a first plate face
120b second plate face
120s front end portion
120t intermediate portion
120k rear end portion
121 gas detection portion
123 heater portion
125,126,127 sensor electrode terminal (electrode terminal portion)
128,129 heater electrode terminal (electrode terminal portion)
130 detection element
137 first solid electrolyte layer
142,143 via conductor
150 second solid electrolyte layer
155 via conductor
160 heater element
170 ceramic sleeve (sleeve)
170c axial hole
170s front end portion
170k protruding portion
170t larger diameter portion
170tm shoulder
180 connector
181 separator
182,183,184 sensor lead frame (connector terminal portion)
185,186 heater lead frame (connector terminal portion)
AX: axis

### DETAILED DESCRIPTION OF THE PREFERRED EMBODIMENTS

The invention will next be described in detail with reference to the drawings. However, the present invention should not be construed as being limited thereto.

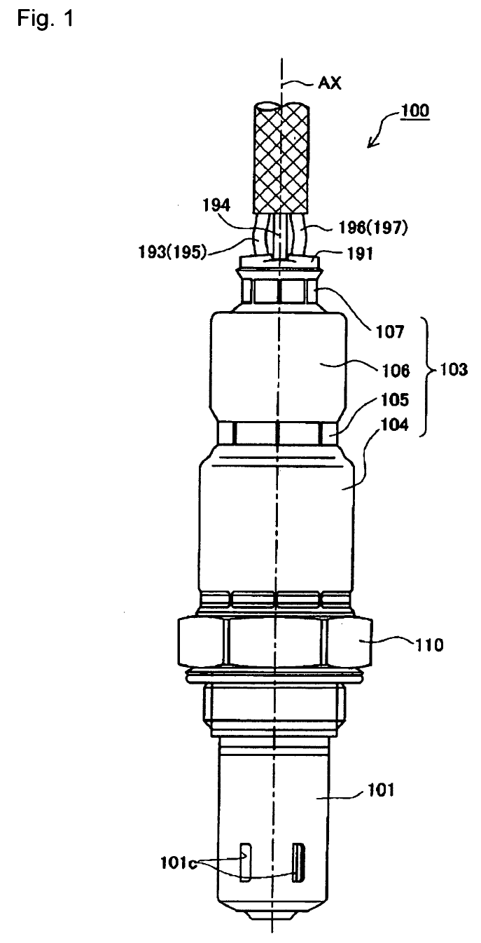

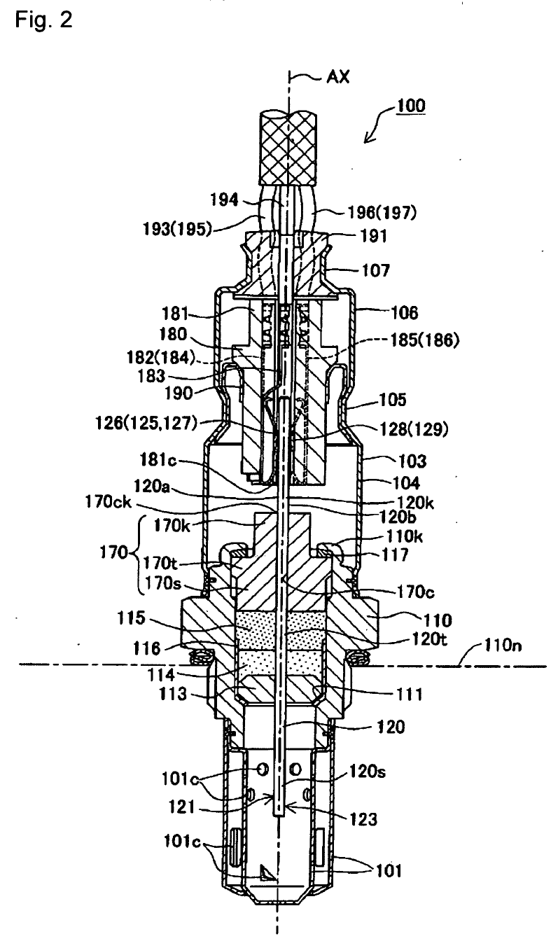

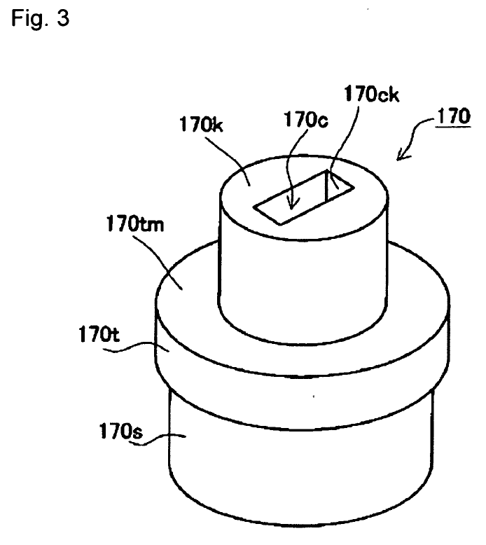

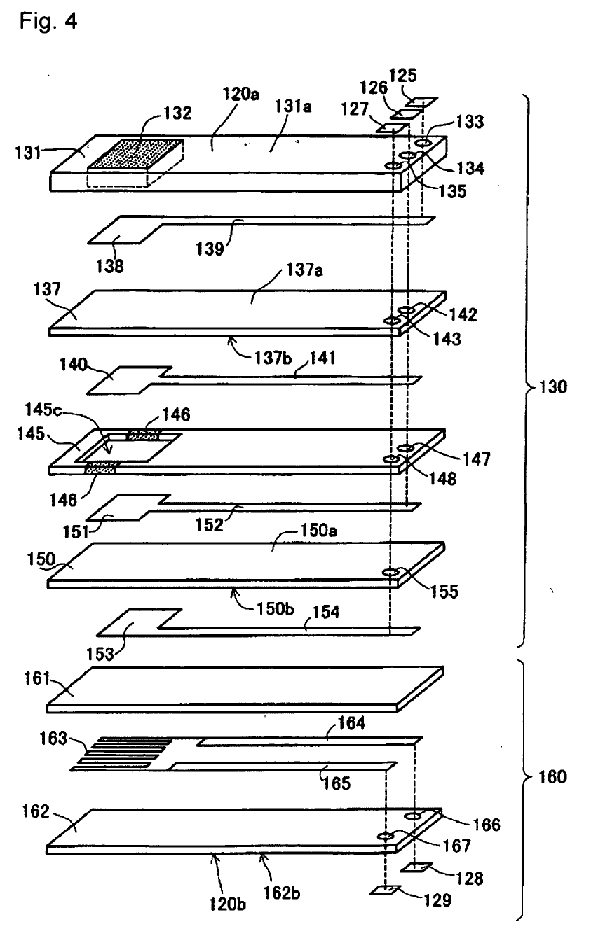

A gas sensor 100 of the present embodiment is illustrated in FIGS. 1 and 2. Also, a ceramic sleeve (sleeve) 170 constituting the gas sensor 100 is illustrated in FIG. 3. Further, a gas detection element 120 (see FIG. 2) constituting the gas sensor 100 is shown in detail in FIG. 4. In addition, in FIGS. 1 to 3, a lower part of the figure will be called a front end side in an axial direction (hereinafter, also called a front end side), and an upper part of the figure will be called a rear end side in an axial direction (hereinafter, also called a rear end side). In order to control air-fuel ratio feedback in an automotive or various types of internal combustion engines, the gas sensor 100 is attached to an exhaust pipe such that a front end side thereof is located inside the exhaust pipe. The gas sensor 100 is an air-fuel ratio sensor for detecting oxygen concentration in an exhaust gas.

As shown in FIGS. 1 and 2, the gas sensor 100 includes a metal shell 110 assuming a cylindrical form as well as extending along an axis AX (axial direction); a plate-like gas detection element 120 extending in an axial direction and located inside the metal shell 110; a cylindrical ceramic sleeve 170 located inside the metal shell 110 and holding and accommodating the gas detection element 120 therein; and a connector 180 fixed at a rear end side of the gas detection element 120 and electrically connected thereto. The gas sensor 100 further includes a protector 101 fixed at a front end side of the metal shell 110; a metal tube 103 fixed at a rear end side of the metal shell 110; a plurality of sensor lead wires 193, 194, 195; and a plurality of heater lead wires 196, 197 extending outside the sensor.

As shown in FIG. 2, the sensor detection element 120 includes an intermediate portion 120t located inside the metal shell 110, a front end portion 120s projecting from the metal shell 110 to the front end side and a rear end portion 120k projecting from the metal shell 110 to the rear end side. Also, a gas detection portion 121 capable of detecting oxygen concentration in an exhaust gas and a heater portion 123 capable of heating the gas detection portion 121 are formed at the front end portion 120s. On the other hand, three sensor electrode terminals (electrode terminal portions) 125, 126, 127 electrically connected to the gas detection portion 121 are formed in a first plate face 120a of the rear end portion 120k, and two heater electrode terminals (electrode terminal portions) 128, 129 electrically connected to the heater portion 123 are formed in a second plate face 120b of the rear end portion 120k.

As shown in an exploded perspective view of FIG. 4, the sensor detection element 120 is formed by laminating a plate-shaped detection element 130 extended in the axial direction (left to right direction in FIG. 4) and a plate-shaped heater element 160 also extending in the axial direction. In addition, in FIG. 4, the left-hand side in the figure indicates the front end side and the right-hand side indicates the rear end side.

The detection element 130 is formed by laminating a protection layer 131, a first solid electrolyte layer 137, a spacer 145 and a second solid electrolyte layer 150—all of which assume the form of a plate—in the order mentioned from the first plate face 120a side to the second plate face 120b side.

The protection layer 131 is mainly composed of alumina. A porous body 132 is formed at the front end side of the protection layer 131. Moreover, the three sensor electrode terminals 125, 126, 127 are formed perpendicular to the axial direction with a predetermined interval, near the rear end of a first face 131a which constitutes the first plate face 120a of the sensor detection element 120. The sensor electrode terminals 125, 126, 127 are electrically connected to three via conductors 133, 134, 135 formed and penetrating through the protection layer 131 near the rear end, as shown with a dotted line in FIG. 4.

The first solid electrolyte layer 137 is composed mainly of zirconia which employs a solid solution of yttria as a stabilizing agent. A first electrode portion 138 composed mainly of Pt, assuming a porous rectangular shape and located at the front end side, and a first lead portion 139 connected to the first electrode portion 138 as well as extending to the rear end side are formed on a first face 137a (upper part in the figure) of a first solid electrolyte layer 137. Near its rear end, the first lead portion 139 is electrically connected to the via conductor 133 formed in and penetrating through the protection layer 131.

Moreover, a second electrode portion 140 composed mainly of Pt, assuming a porous rectangular shape and located in the front end side, and a second lead portion 141 connected to the second electrode portion 140 as well as extending to the rear end side are formed on a second face 137b (lower part in the figure) of the first solid electrolyte layer 137. Furthermore, a pair of via conductors 142, 143 is formed near the rear end of the first solid electrolyte layer 137 and penetrates therethrough. The via conductors 142, 143 are electrically connected to the via conductors 134, 135 formed in and penetrating through the protection layer 131. Further, near its rear end, the second lead portion 141 is electrically connected to the via conductor 142 formed in and penetrating through the first solid electrolyte layer 137.

A spacer 145 is composed mainly of alumina and includes a rectangular opening 145c at the front end side. The opening 145c serves as a measurement gas chamber formed by the spacer 145 sandwiched between the first solid electrolyte layer 137 and the second solid electrolyte layer 150. A part of both side walls of the opening 145c is composed of a porous body 146 limiting the ventilation between the inside and outside of the opening 145c. The porous body 146 is made of porous alumina. Moreover, a pair of via conductors 147, 148 is formed near the rear end of the spacer 145. The via conductor 147 is electrically connected to the second lead portion 141. Also, the via conductor 148 is electrically connected to the via conductor 143 formed in and penetrating through the first solid electrolyte layer 137.

A second solid electrolyte layer 150 is composed mainly of zirconia which employs a solid solution of yttria as a stabilizing agent. A third electrode portion 151 composed mainly of Pt, located at the front end side and having a porous rectangular shape, and a third lead portion 152 connected to the third electrode portion 151 as well as extending to the rear end side are formed on a first face 150a (upper part in the figure) of the second solid electrolyte layer 150. Near its rear end, the third lead portion 152 is electrically connected to a via conductor 147 formed in and penetrating through the spacer 145.

Moreover, a fourth electrode portion 153 located at the front end side and assuming a porous rectangular shape, and a fourth lead portion 154 connected to the fourth electrode portion 153 as well as extending to the rear end side are formed on a second face 150b (lower part in the figure) of the second solid electrolyte layer 150. Furthermore, a via conductor 155 is formed near the rear end of the second solid electrolyte layer 150 and penetrates therethrough. The via conductor 155 is electrically connected to the fourth lead portion 154 and the via conductor 148 formed in and penetrating through the spacer 145.

Next, a heater element 160 will be explained. The heater element 160 is formed by laminating a first insulating layer 161 and a second insulating layer 162, both of which are made of alumina and assume the form of a plate, in the order mentioned from a first plate face 120a side to a second plate face 120b side. A heating resistive body 163 composed mainly of Pt, assuming a zigzag form and located at the front end side, and heater lead portions 164, 165 connected to both ends of the heating resistive body 163 respectively, as well as extending to the rear end side are formed between the first insulating layer 161 and the second insulating layer 162.

Further, a pair of via conductors 166, 167 is formed near the rear end of the second insulating layer 162 and penetrates therethrough. Furthermore, the heater electrode terminals 128, 129 are formed side by side in a direction perpendicular to the axis at near the rear end of a second face 162b, which constitutes the second plate face 120b of the sensor detection element 120. The heater electrode terminal 128 is electrically connected to the heater lead portion 164 through the via conductor 166. Moreover, the heater electrode terminal 129 is electrically connected to the heater lead portion 165 through the via conductor 167.

Next, returning to FIGS. 1 and 2, the structure of the gas sensor 100 will be explained.

The cylindrical metal shell 110 extends in the axial direction in which a platform portion 111 projecting radially inward is formed. Also, a cylindrical ceramic holder 113 made of alumina, a first powder filling layer 114 made of talc powder, glass powder or the like, a second powder filling layer 115 which is also made of talc powder, glass powder or the like and the cylindrical ceramic sleeve 170 made of alumina are formed in the metal shell 110 in the order mentioned from the front end side to rear end side. Further, a cylindrical metal cup 116 is located in the metal shell 110. Furthermore, a crimping ring 117 is located between the ceramic sleeve 170 and a rear end portion 110k of the metal shell 110.

The ceramic holder 113 is located at the front end side of the metal cup 116 and engages the platform portion 111 of the metal shell 110 through the metal cup 116. The gas detection element 120 penetrates through the ceramic holder 113. Moreover, the whole portion of the first powder filling layer 114 and a part of the front end side of the second powder filling layer 115 are located in the metal cup 116.

As shown in FIGS. 2 and 3, the ceramic sleeve 170 which is located in the rear end side of the second powder filling layer 115, assumes a cylindrical form having an axial hole 170c therein that extends along an axis AX and has a rectangular opening. In detail, the ceramic sleeve 170 includes a front end portion 170s; a protruding portion 170k extending beyond the metal shell 110 toward the rear end side; and a large diameter portion 170t located between the front end portion 170s and the protruding portion 170k and having a diameter larger than that of the front end portion 170s and the protruding portion 170k.

Furthermore, the axial length of the protruding portion 170k is 6 mm in this embodiment. The axial length of the protruding portion 170k is preferably set within a range from 2 mm to 10 mm. The area of the rear end face of the protruding portion is 35 mm² in this embodiment. The area of the rear end face of the protruding portion is preferably set within a range from 30 mm² to 50 mm².

The ceramic sleeve 170 holds the plate-shaped gas detection element 120 such that the gas detection element 120 penetrates through the axial hole 170c which assumes a rectangular form. That is, in the ceramic sleeve 170, the front end portion 170s, the large diameter portion 170t as well as the protruding portion 170k hold and support the gas detection element 120 such that the gas detection element 120 penetrates therethrough.

Moreover, the larger diameter portion 170t of the ceramic sleeve 170 has a shoulder 170tm which faces the rear end side. Then, the ceramic sleeve 170 is fixed inside the metal shell 110 by bending the rear end portion 110k of the metal shell 110 inwardly, and crimping it to the shoulder 170tm of the larger diameter portion 170t through a crimping ring 117.

Next, as shown in FIGS. 1 and 2, the protector 101 having a closed front end is fixed at the front end side of the metal shell 110 by laser welding so as to cover the front end portion 120s of the gas detection element 120 projecting from the metal shell 110. The protector 101 has a plurality of feeding holes 101c in predetermined positions which allow the exhaust gas to flow into protector 101.

The structure of the rear end side beyond the metal shell 110 will next be explained. The cylindrical metal tube 103 is fixed at the rear end side of the metal shell 110 by laser welding. The metal tube 103 includes a first portion 104 located in the front end side and having the largest diameter; a second portion 105 located to the rear of the first portion 104 and crimped in a radially inward direction; a third portion 106 located to the rear of the second portion 105; and a fourth portion 107 located to the rear of the third portion 106, crimped in a radially inward direction and having the smallest diameter.

In the metal tube 103, a connector 180 is placed inside the first portion 104 and extends to the third portion 106. The connector 180 is composed of: a separator 181 made of ceramic, three sensor lead frames (connector terminal portion) 182, 183, 184 and a pair of heater lead frames (connector terminal portion) 185, 186. The separator 181 accommodates the sensor lead frames 182, 183, 184 and the heater lead frames 185, 186 so that they do not contact one another (i.e., so that they are isolated from one another).

The connector 180 is mounted on the rear end side of the gas detection element 120 so as to isolate the same from the ceramic sleeve 170. Specifically, a part of the rear end side of the gas detection element 120 that projects from the protruding portion 170k of the ceramic sleeve 170 is inserted into an opening 181c of the separator 181 that opens at the front end side. Then, the sensor lead frames 182, 183, 184 are resiliently held in contact with and electrically connected to respective sensor electrode terminal 125, 126, 127 of the gas detection element 120. Moreover, the heater lead frames 185, 186 are resiliently in contact with and electrically connected to each heater electrode terminal 128, 129 of the gas detection element 120.

In this embodiment, the axial distance between the rear end face of the sleeve 170 and the contact portion between the lead frames 182 to 186 and electrode terminals 125 to 129 of the gas detection element 120 is 9 mm. This axial distance is preferably set to be within a range from 5 mm to 30 mm.

Moreover, the connector 180 is held by the metal tube 103 by a biasing metal fitting 190 located around the connector 180 and assuming a generally cylindrical shape, while being biased at the rear end side so as to attach to a grommet 191 discussed below. The biasing metal fitting 190 is located inside the second portion 105 of the metal tube 103 and crimped and fixed by the second portion 105.

On the other hand, inside the fourth portion 107 of the metal tube 103, a grommet 191 made of a fluorocarbon rubber is provided, and two heater lead wires 196, 197 and three sensor lead wires 193,194,195 are inserted in the grommet 191. The grommet 191 is fixedly crimped by the fourth portion 107. The front end side of each sensor lead 193, 194, 195 is inserted into a connector 180 and fixedly crimped by the sensor lead frames 182, 183, 184 so as to electrically connect respective sensor leads and sensor lead frames. Moreover, the front end side of each heater lead 196, 197 is inserted into the connector 180 and fixedly crimped by the heater lead frame 185,186 so as to electrically connect respective heater leads and heater lead frames.

As explained above, the gas detection element 120 according to the present embodiment includes first and second solid electrolyte layers 137, 150 in a rear end portion 120k thereof, and the via conductors 142, 143, 155 are formed in these electrolyte layers which penetrate therethrough (refer to FIG. 4). Thus, if the rear end portion 120k of the gas detection element 120 is exposed to a high temperature, the insulating capability of the first and second solid electrolyte layers 137, 150 in the rear end portion 120k will fail, whereby a leak between the via conductors 142 and 143 tends to occur. Consequently, the gas concentration may not be accurately detected.

However, in the present embodiment, since the ceramic sleeve 170 is isolated from the connector 180, the heat from the ceramic sleeve 170 is hardly conducted to the connector 180, thereby preventing too high of a temperature increase of the connector 180 when in use. Consequently, leakage between via conductors 142 and 143 due to high temperature is unlikely to occur whereby the gas concentration may be more accurately detected than by a conventional gas sensor.

Moreover, in the gas sensor 100, the ceramic sleeve 170, which holds and accommodates the gas detection element 120 penetrating therethrough, includes the protruding portion 170k which extends beyond the metal shell 110 towards the rear end side and also holds the gas detection element 120 therein. Thus, since the protruding portion 170k supports the gas detection element 120, damage to the gas detection element 120 is efficiently prevented even if an external force is applied to the rear end side of the gas detection element 120. Accordingly, the gas detection element 120 is better protected from breakage than in a conventional gas sensor, during a mounting process of mounting the connector 180 to the gas detection element 120, or during a subsequent assembling process.

Next, a method of manufacturing the gas sensor 100 will be explained.

First, the gas detection element 120 is basically produced by a known technique. Then, the gas detection element 120 is inserted into the ceramic holder 113, and the thus-assembled body is placed in the metal cup 116. Subsequently, a talc ring is inserted into the metal cup 116 from the rear end side and pressed toward the front end side so as to fix the gas detection element 120.

Next, thus-produced assembly is inserted into the metal shell 110 from the rear end side, and another talc ring and the ceramic sleeve 170 are inserted in the order mentioned from the rear end side. In addition, the protector 101 is fixed at the front end side of the metal shell 110 beforehand by laser welding. Then, the rear end portion 110k of the metal shell 110 is bent toward the radially-inward direction and crimped toward the shoulder 170tm of the larger diameter portion 170t of the ceramic sleeve 170 through the crimping ring 117, to thereby fix the ceramic sleeve 170 and the gas detection element 120 or the like to the metal shell 110. In this manner, a lower assembly is completed.

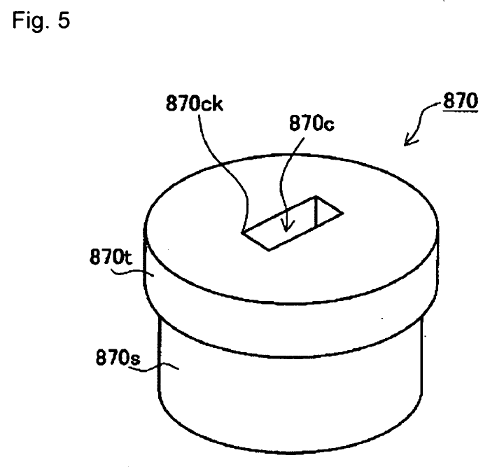

If the sleeve 170 is entirely located in the metal shell 110 and has no protruding portion 170k (i.e., the form shown in FIG. 5), a large tensile stress will be imposed around a rear end side open end portion 870ck of an axial hole 870c when the rear end portion 110k of the metal shell 110 is bent inwardly to crimp a sleeve 870. Consequently, starting from the stressed portion, cracks may be generated in the sleeve 870. Specifically, when the axial hole 870c of the sleeve 870 has a rectangular-shaped opening, a large tensile stress is likely to be imposed, especially, on a corner of the rear end side open end portion 870ck. As a result, a crack tends to occur in the sleeve 870 when the rear end portion 110k of the metal shell 110 is crimped.

However, in the present embodiment, since the sleeve 170 has a protruding portion 170k projecting to the rear end side, the rear end side open end portion 170ck of the axial hole 170c where a crack tends to initiate is isolated from the rear end portion 110k (crimped portion) of the metal shell 110 to the rear end side (see FIG. 2). Therefore, owing to such a stress dispersing structure, the occurrence of a crack in the sleeve 170 can be prevented.

Next, an upper assembly is produced. First, the sensor lead frames 182, 183, 184 to which the sensor lead wires 193, 194, 195 are connected, respectively, and the heater lead frames 185, 186 to which the heater leads 196, 197 are connected, respectively, are located inside the separator 181. On the other hand, the biasing metal fitting 190 is attached in a predetermined position of an outer circumference of the separator 181.

Next, the grommet 191 is located at the rear end side of the separator 181, and the thus-assembled body is inserted into the metal sleeve 103 from the grommet 191 side. Then, the second portion 105 of the metal tube 103 is crimped in the radially inward direction. This deforms the biasing metal fitting 190 located inside the metal sleeve, whereby the separator 181 is biased to the rear end side. Thus, the upper assembly is completed.

Next, the rear end side of the gas detection element 120 is inserted into the opening 181c of the connector 180 (separator 181) by relatively moving the upper assembly and the lower assembly toward one another. Thereby, the sensor lead frames 182, 183, 184 of the connector 180 and the heater lead frames 185, 186 are in resilient contact with and electrically connected to corresponding sensor electrode terminals 125, 126, 127 of the gas detection element 120 and the heater electrode terminals 128, 129, respectively.

Next, the fourth portion 107 of the metal tube 103 is crimped in the radially inward direction to thereby fix the grommet 190 located inside the metal tube. Further, the front end portion of the metal tube 103 is crimped in the radially inward direction and the thus-crimped portion is laser welded so that the metal tube 103 may be fixed to the metal shell 110. In this way, the gas sensor 100 is completed.

### First Embodiment

In order to verify the effect of the present invention, samples of the gas sensors 100 according to the present embodiment were produced. Comparative samples including a ceramic sleeve 170 attached to the connector 180, representative of a conventional configuration, were also prepared.

First, in samples of the present embodiment and the comparative samples, the gas sensors 100 were operated so that the temperature of the metal shell 110, which was positioned 3 mm apart from a flange 110n of the metal shell 110 (see FIG. 2) to the rear end side, reached a temperature of 700° C. Then, the temperature of the contact portion, which was positioned 26 mm apart from a flange 110n of the metal shell 110 to the rear end side, between the gas detection element 120 (the sensor electrode terminals 125,126,127 and the heater electrode terminals 128,129) and the connector 180 (the sensor lead frames 182,183,184 and the heater lead frames 185,186) was measured. Moreover, the temperature of the grommet 191, which was positioned 48 mm apart from the flange 110n of the metal shell 110 to the rear end side, was measured.

Also, the gas sensors 100 of the present embodiment samples and the comparative samples were operated so that the temperature of the metal shell 110, which was positioned 3 mm apart from a flange 110n of the metal shell 110 (see FIG. 2) to the rear end side, reached a temperature of 650° C. Similar to the above, the temperature of the contact portion, which was positioned 26 mm apart from a flange 110n of the metal shell 110 to the rear end side, and the temperature of the grommet 191, which was positioned 48 mm apart from the flange 100n of the metal shell 110 to the rear end side, were measured, respectively. The results are collectively shown in Table 1.

TABLE 1

| | | Contact Portion | |
|---|---|---|---|
| | Metal shell (° C.) | (° C.) | Grommet (° C.) |
| Inventive | 700 | 440 | 300 |
| Samples | 650 | 410 | 280 |
| Comparative | 700 | 500 | 320 |
| Samples | 650 | 450 | 300 |

As shown in Table 1, in the samples of the invention, when the temperature of the metal shell 110 was set at 700° C., the temperature of the contact portion reached 440° C., and that of the grommet 191 reached 300° C. On the other hand, in the comparative samples, when the temperature of the metal shell 110 was set at 700° C., the temperature of the contact portion reached 500° C., and that of the grommet 191 reached 320° C. The above test results show that the temperature rise of both the contact portion and the grommet 191 in the embodiment of the present invention (where the connector is spaced apart from the sleeve) is considerably less than in the comparative samples (where the connector is attached to the sleeve).

Moreover, in the samples of the present embodiment, when the temperature of the metal shell 110 was set at 650° C., the temperature of the contact portion reached 410° C., and that of the grommet 191 reached 280° C. On the other hand, in the comparative samples, when the temperature of the metal shell 110 was set at 650° C., the temperature of the contact portion reached 450° C., and that of the grommet 191 reached 300° C. These results confirm that both the temperature rise of the contact portion and the grommet 191 in the embodiment of the present invention is restrained.

As described above, when the rear end portion 120k of the gas detection element 120 is exposed to a high temperature, the insulation performance of the first and second solid electrolyte layers 137, 150 in the rear end portion 120k can fail, thereby likely causing a leak between the via conductors 142, 143 formed therein. Consequently, the gas concentration may not be accurately detected. However, since the ceramic sleeve 170 is isolated from the connector 180 in the present embodiment, the temperature rise of the contact portion, etc., is restrained. Therefore, by applying the present invention, the leakage between the via conductors 142, 143 due to high temperature is more effectively prevented as compared to that of a conventional gas sensor, leading to accurate detection of the gas concentration.

### Second Embodiment

In order to verify the effect of the present invention, ten lower assemblies each constituting the gas sensor 100 according to the above-mentioned embodiment were prepared. Further, another ten lower assemblies were prepared as comparative samples, in which the ceramic sleeve 870 as illustrated in FIG. 5 was employed instead of the ceramic sleeve 170 shown in FIG. 3, and the rest of the constitution thereof was the same as the above-mentioned embodiment. The ceramic sleeve 870 does not include the protruding portion at the rear end side. That is, the ceramic sleeve 870 is only comprised of: a front end portion 870s equivalent to the front end portion 170s of the ceramic sleeve 170 in FIG. 3; and a large diameter portion 870t equivalent to the large diameter portion 170t of the ceramic sleeve 170. Moreover, similar to the ceramic sleeve 170 shown in FIG. 3, the axial hole 870c having a rectangular-shaped opening is formed along the axis in the ceramic sleeve 870.

An external force was applied to the rear ends of the gas detection elements 120 of the respective samples to evaluate resistance to element breakage. In detail, the rear ends of the gas detection elements 120 of each of the five samples of the present embodiment and the comparative samples was pressed, with increasing force, in the direction perpendicular to the axis as well as the direction perpendicular to the first and second plate faces 120a, 120b (hereinafter referred to as the X-direction) to the point where either the gas detection element 120 or the ceramic sleeves 170, 870 was damaged. Moreover, the rear ends of the gas detection elements 120 of the remaining samples were pressed, with increasing force, in the direction perpendicular to the axis as well as the direction parallel to the first and second plate faces 120a and 120b (hereinafter referred to as the Y-direction) to the point where either the gas detection element 120 or the ceramic sleeves 170, 870 was damaged. The results are collectively shown in Table 2.

TABLE 2

| | Sample | Pressing | Breaking | Breaking Strength |
|---|---|---|---|---|
| | No. | Direction | Strength (N) | Avg. Value (N) |
| Inventive | 1 | X | 32.8 | 33.4 |
| Samples | 2 | | 38.4 | |
| | 3 | | 29.6 | |
| | 4 | | 38.7 | |
| | 5 | | 27.4 | |
| | 6 | Y | 85.0 | 114.5 |
| | 7 | | 93.0 | |
| | 8 | | 120.5 | |
| | 9 | | 126.6 | |
| | 10 | | 147.5 | |
| Comparative | 11 | X | 23.0 | 21.4 |
| Samples | 12 | | 22.3 | |
| | 13 | | 19.8 | |
| | 14 | | 20.2 | |
| | 15 | | 21.5 | |
| | 16 | Y | 89.0 | 89.6 |
| | 17 | | 95.2 | |
| | 18 | | 61.8 | |
| | 19 | | 125.1 | |
| | 20 | | 77.0 | |

As shown in Table 2, in Samples 1-5 of the present embodiment whose rear end of the gas detection element 120 was pressed in the X-direction, the breakage strength thereof, namely, the force resulting in damage to either the gas detection element 120 or the ceramic sleeve 170, was 32.8N, 38.4N, 29.6N, 38.7N and 27.4N, respectively (average: 33.4 N). On the other hand, in Comparative Samples 11-15 where the rear end of the gas detection element 120 was also pressed in the X-direction, the breakage strength thereof, namely, the force resulting in damage to either the gas detection element 120 or the ceramic sleeve 870, was 23.0N, 22.3N, 19.8N, 20.2N and 21.5N, respectively, (average: 21.4N). These results show that the breakage strength of the inventive samples was about 56%, on average, higher than that of the comparative samples.

Furthermore, in Samples 6-10 of the present embodiment whose rear end of the gas detection element 120 was pressed in the Y-direction, the breakage strength thereof was 85.0N, 93.0N, 120.5N, 126.6N and 147.5N, respectively, (average: 114.5N) at the point where either the gas detection element 120 or the ceramic sleeve 170 was damaged. On the other hand, in Comparative Samples 16-20 where the rear end of the gas detection element 120 was also pressed in the Y-direction, the breakage strength thereof was 89.0N, 95.2N, 61.8N, 125.1N and 77.0N, respectively, (average: 89.6N) at the point where either the gas detection element 120 or the ceramic sleeve 870 was damaged. These results show that the breakage strength of the inventive samples was about 27%, on average, higher than that of the comparative samples.

The above results demonstrate that the gas detection element 120 is protected from breakage, even if an external force is applied to the rear end side of the gas detection element 120, by providing the protruding portion 170k in the ceramic sleeve 170 and by holding and accommodating the gas detection element 120 therein. Therefore, the gas sensor according to the present invention, and specifically the gas detection element 120, more effectively resists breakage when attaching the connector 180 to the gas detection element 120 or during subsequent assembly, as compared to a conventional gas sensor.

The present invention has been explained according to the above embodiment, however, the invention is not limited thereto and may be changed or modified in various ways within the scope of the invention.

This application is based on Japanese Patent Application No. 2005-128374 filed Apr. 26, 2005, incorporated herein by reference in its entirety.

1. A gas sensor comprising:
a cylindrical metal shell;
a gas detection element including a solid electrolyte layer, a front end portion of the gas detection element projecting from a front end portion of the metal shell and including a gas detection portion, an intermediate portion located inside the metal shell, and a rear end portion projecting from a rear end portion of the metal shell and including a plurality of electrode terminal portions and a plurality of via conductors electrically connected to corresponding electrode terminal portions;
a cylindrical sleeve at least partially located inside the metal shell, and an axial hole penetrating through the sleeve and accommodating the gas detection element therein; and
a connector joined to the rear end portion of the gas detection element and spaced apart from the sleeve, the connector including a plurality of connector terminal portions electrically connected to corresponding electrode terminal portions.

2. The gas sensor as claimed in claim 1,
wherein the sleeve further includes a projecting portion projecting from the rear end portion of the metal shell and supporting said gas sensor element.

3. The gas sensor as claimed in claim 1,
wherein the sleeve further includes a large diameter portion having a larger diameter than that of the protruding portion and a shoulder portion facing the rear end in the axial direction, and
wherein the rear end portion of the metal shell is bent inwardly so as to crimp the shoulder portion.

4. The gas sensor as claimed in claim 2,
wherein the sleeve further includes a large diameter portion having a larger diameter than that of the protruding portion and a shoulder portion facing the rear end in the axial direction, and
wherein the rear end portion of the metal shell is bent inwardly so as to crimp the shoulder portion.
